(19) United States
(12) Patent Application Publication
(10) Pub. No.: US 2024/0378456 A1
(43) Pub. Date: Nov. 14, 2024

(54) AUTHENTICATION BASED SECURE FEDERATED LEARNING

(71) Applicant: Micron Technology, Inc., Boise, ID (US)

(72) Inventors: Shashank Bangalore Lakshman, Folsom, CA (US); Pavana Prakash, Houston, TX (US); Poorna Kale, Folsom, CA (US)

(21) Appl. No.: 18/658,041

(22) Filed: May 8, 2024

Related U.S. Application Data
(60) Provisional application No. 63/465,089, filed on May 9, 2023.

(51) Int. Cl. G06N 3/098

(52) U.S. Cl. CPC G06N 3/098

(57) ABSTRACT

Authentication based secure federated learning can be beneficial when updates to an initial artificial neural network (ANN) model generated by edge devices are to be aggregated into a federated ANN model. The updates can be generated by the edge devices after training the initial ANN locally. The edge devices can encrypt the updates using edge device-specific identifiers and transmit the encrypted updates to a server. The server can verify the authenticity of the updates, decrypt the updates, and aggregate the updates into the federated ANN model. The aggregation can be performed according to a secure multiparty computation protocol.

### PRIORITY INFORMATION

This application claims the benefits of U.S. Provisional Application No. 63/465,089, filed on May 9, 2023, the contents of which are incorporated herein by reference.

### TECHNICAL FIELD

The present disclosure relates generally to apparatuses, non-transitory machine-readable media, and methods associated with authentication based secure federated learning.

### BACKGROUND

A computing device can be, for example, a personal laptop computer, a desktop computer, a server, a smart phone, smart glasses, a tablet, a wrist-worn device, a mobile device, a digital camera, and/or redundant combinations thereof, among other types of computing devices. Computing devices can be used to implement artificial neural networks (ANNs). Computing devices can also be used to train the ANNs.

ANNs are networks that can process information by modeling a network of neurons, such as neurons in a human brain, to process information (e.g., stimuli) that has been sensed in a particular environment. Similar to a human brain, neural networks typically include a multiple neuron topology, which can be referred to as artificial neurons. An ANN operation refers to an operation that processes inputs using artificial neurons to perform a given task. The ANN operation may involve performing various machine learning algorithms to process the inputs. Example tasks that can be processed by performing ANN operations can include machine vision, speech recognition, machine translation, social network filtering, and medical diagnosis, among others.

### BRIEF DESCRIPTION OF THE DRAWINGS

FIG. 1 is a block diagram of a system for authentication based secure federated learning.

FIG. 2 is a functional block diagram for authentication based secure federated learning.

FIG. 3 is a flow diagram corresponding to a method for authentication based secure federated learning.

FIG. 4 is a block diagram of a computer system in which embodiments may operate.

### DETAILED DESCRIPTION

The present disclosure describes apparatuses and methods related to authentication based secure federated learning. A federated ANN model is an ANN model that is trained and/or updated by federated learning. As used herein, “federated learning” refers to an approach to training an ANN across multiple decentralized edge devices using local datasets without exchanging the local datasets between the decentralized edge devices. In contrast to other approaches in which local datasets are uploaded to a host system (e.g., a server) or that assume identical distribution of the local datasets, federated learning can enable multiple devices to individually contribute to the generation of a common, robust machine learning model without sharing data between the edge devices. This can also avoid the need for large server farms to provide the necessary compute and memory resources to perform the training. As a result, issues, such as data privacy, data security, data access rights, and access to heterogeneous data, for example, can be addressed.

Federated learning can include a host system communicating (e.g., broadcasting) an initial ANN model to multiple devices. In federated learning, one or more local datasets are used to train and/or retrain the initial ANN model on the edge devices. Local versions (e.g., updated versions) of the initial ANN model or just the updates themselves (e.g., updated weights, biases, activation functions, etc. of the model) are communicated from one or more of the edge devices to the host system. The host system can aggregate the updates from multiple edge devices into a federated ANN model, which can be communicated from the host system to the edge devices. The communication of the federated ANN model can include transmitting signals indicative of the entire federated ANN model or only updated portions of the federated ANN model (e.g., updated weights, biases, activation functions, etc.).

The edge devices can be drones, cameras such as network video recorders, cell phones, internet of things (IoT) device, or another electronic device. The edge devices can exist within a heterogeneous system and can participate in jointly training the initial ANN model without sharing raw input data, thus protecting the training dataset. However, a rogue edge device can participate in the learning process and inject malicious packets into the system, challenging the security of the system. In the case of an untrusted and/or compromised server, an adversary can access the ANN models associated with the edge devices and perform reverse engineering inversion attacks that reveal the private dataset and/or information on the edge devices.

Embodiments of the present disclosure address the above deficiencies and other deficiencies of previous approaches with a bilevel authentication method to prevent a third-party and/or a malicious device from hindering the learning process. An edge device can store an edge device-specific identifier in one or more blocks of a memory device (e.g., a persistent memory, such as flash memory) of the edge device. The one or more blocks of the memory device can be secured by hardware of the memory device that isolates access to the one or more blocks. By adding an edge device-specific secure identity directly to memory of the edge device, system level security can be strengthened. The hardware of the memory device that secures access to the blocks of memory in which the identifier is stored can provide a root of trust for authentication. This edge device-specific identifier can be used by a server that aggregates updates into a federated ANN model for edge device authentication and/or updates therefrom to overcome system security challenges.

In order to provide security at the server level, a secure aggregation protocol, such as a secure multiparty computation protocol, can be used to further protect the integrity of the edge devices. A secure multiparty computation protocol can allow for the computation of a function over inputs from multiple parties while keeping the inputs private from the other parties. For example, instead of one-step averaging of inputs, inputs from different parties can be randomly sampled (e.g., randomly sample ANN model parameter updates from different edge devices).

As used herein, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected.

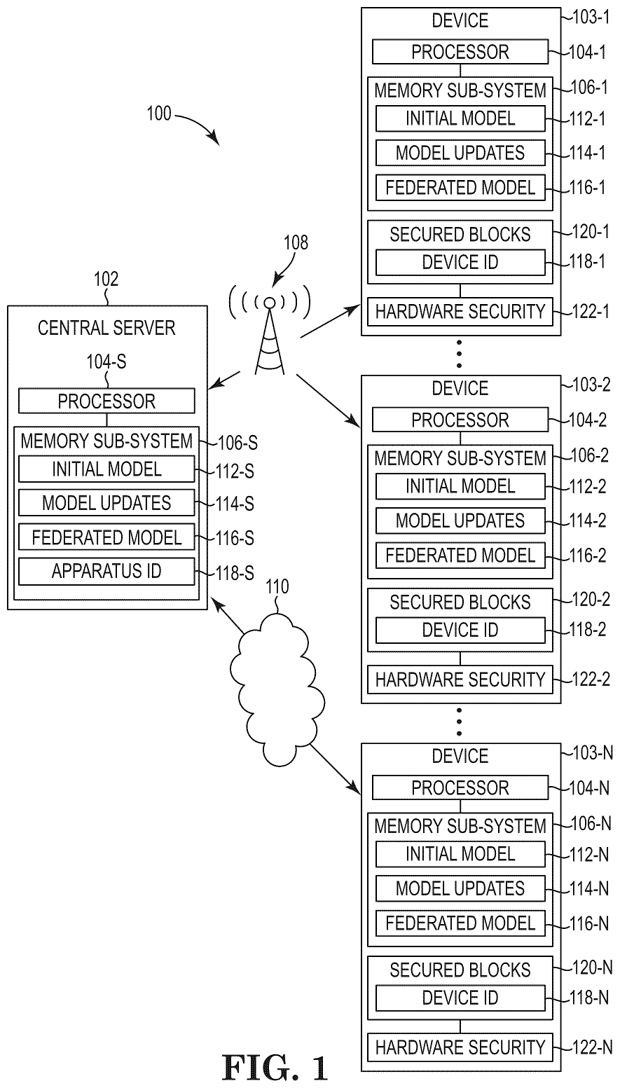

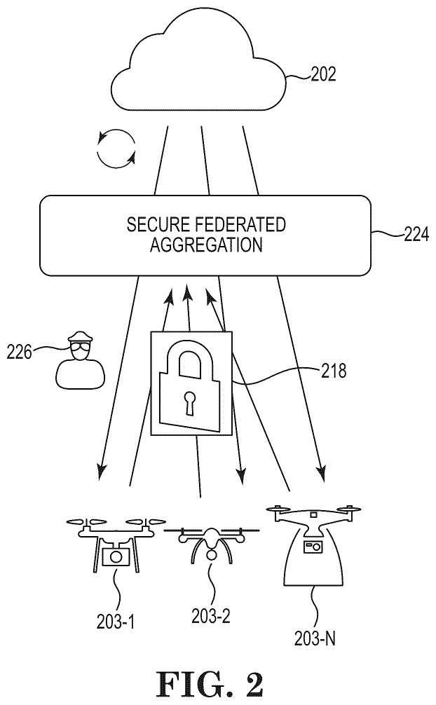

The figures herein follow a numbering convention in which the first digit or digits correspond to the drawing figure number and the remaining digits identify an element or component in the drawing. Similar elements or components between different figures may be identified by the use of similar digits. For example, 103-1 may reference element “03” in FIG. 1, and a similar element may be referenced as 203-1 in FIG. 2. Analogous elements within a Figure may be referenced with a hyphen and extra numeral or letter. See, for example, elements 103-1, 103-2, . . . , 103-N in FIG. 1. Such analogous elements may be generally referenced without the hyphen and extra numeral or letter. For example, elements 103-1, . . . , 103-N may be collectively referenced as 103. As used herein, the designators “N” and “S”, particularly with respect to reference numerals in the drawings, indicates that a number of the particular feature so designated can be included. As will be appreciated, elements shown in the various embodiments herein can be added, exchanged, and/or eliminated so as to provide a number of additional embodiments. In addition, as will be appreciated, the proportion and the relative scale of the elements provided in the figures are intended to illustrate certain embodiments of the present invention and should not be taken in a limiting sense.

FIG. 1 is a block diagram of a system for authentication based secure federated learning. The system 100 can include a server 102 and edge devices 103-1, 103-2, . . . , 103-N. The system 100, the server 102, and the edge devices 103 can include hardware, firmware, and/or software configured to train an ANN model. As used herein, an ANN model can include a plurality of weights, biases, and/or activation functions among other variables that can be used to execute an ANN. The server 102 and the edge devices 103 can further include memory sub-systems 106-1, 106-2, 106-N, 106-S (e.g., a non-transitory MRM), on which may be stored instructions and/or data. Although the following descriptions refer to a processing device and a memory device, the descriptions may also apply to a system with multiple processing devices and multiple memory devices. In such examples, the instructions may be distributed (e.g., stored) across multiple memory devices and the instructions may be distributed (e.g., executed by) across multiple processing devices.

The memory sub-systems 106 can be memory devices. The memory devices can be electronic, magnetic, optical, or other physical storage devices that store executable instructions. The memory devices can include non-volatile or volatile memory. In some examples, the memory device is a non-transitory MRM comprising random access memory (RAM), an Electrically-Erasable Programmable read only memory (EEPROM), flash memory, a storage drive, an optical disc, and the like. Executable instructions (e.g., training instructions, aggregation instructions, etc.) can be “installed” on the server 102 and/or the edge devices 103. The memory sub-systems 106 can be portable, external, or remote storage mediums, for example, that allow the server 102 and/or the edge devices 103 to download the instructions from the portable/external/remote storage mediums. In this situation, the executable instructions may be part of an “installation package.” As described herein, the memory sub-systems 106 can be encoded with executable instructions for training an ANN and aggregating updates to an ANN, among other functions described herein.

The server 102 can execute instructions using the processor 104-S. The instructions can be stored in the memory sub-system 106-S prior to being executed by the processor 104-S. The execution of the instructions can cause the initial ANN model 112-S to be provided to the edge devices 103.

The edge devices 103 can execute instruction using the processors 104-1, 104-2, . . . , 104-N to store and train the initial ANN model 112-1, 112-2, . . . , 112-N. Although only three edge devices 103 are illustrated as storing and training the initial ANN model 112, any number of edge devices may do so in practice.

Although not specifically illustrated, the edge devices 103 can each receive respective local data from operation in a respective location. The edge devices 103 can store the respective local data and/or train the initial ANN model 112 with the respective local data. The edge devices 103 can train the initial ANN model 112 by executing instructions using the processors 104. Although not specifically illustrated, the edge devices 103 can include artificial intelligence (AI) accelerators such as deep learning accelerators (DLAs), which can be utilized to train ANN models. As used herein, AI refers to the ability to improve an apparatus through “learning” such as by storing patterns and/or examples which can be utilized to take actions at a later time. Deep learning refers to a device's ability to learn from data provided as examples. Deep learning can be a subset of AI. Neural networks, among other types of networks, can be classified as deep learning. In various examples, processors 104 are described for performing the examples described herein. AI accelerators can also be utilized to perform the examples described herein instead of or in concert with the processors 104. The edge devices 103 can provide a function according to operation of the initial ANN model 112, for example, by executing the initial ANN model 112 utilizing the processors 104. In various examples, the processors 104 can be internal to the memory sub-systems 106 instead of being external to the memory sub-systems 106 as shown. For instance, the processors 104 can be processor-in-memory (PIM) processors. The processors 104 can be incorporated into the sensing circuitry of the memory sub-systems 106 and/or can be implemented in the periphery of the memory sub-system 106, for instance. The processors 104 can be implemented under one or more memory arrays of the memory sub-system 106.

Training an ANN model can include a forward pass (e.g., forward propagation) of the ANN model and a loss back propagation (e.g., backward propagation) through the ANN model. A loss calculation utilizing the output of the ANN model can be performed. The loss calculation (e.g., loss function) can be used to measure how well the ANN model models the training data. Training minimizes a loss between the output of the ANN model and the target outputs. Parameters (e.g., weights, biases, and/or activation functions) can be adjusted to minimize the average loss between the output of the ANN model and the target output. The parameters of the ANN model can be adjusted by the devices 103 and/or the server 102. Other training methods can be used.

The loss function can be any one of a number of loss functions. For example, the loss function can be a mean square error loss function or a mean absolute error loss function. Back propagation includes computing the gradient of the loss function with respect to the weights of the ANN model for a single input-output example. Gradient algorithms can be used for training multilayer ANN models, updating weights to minimize loss, for example, using gradient descent or variants such as stochastic gradient descent. Back propagation works by computing the gradient of the loss function with respect to each weight by the chain rule. The chain rule can describe the computing of the gradient one layer at a time.

As a result of training the initial ANN model 112, the edge devices 103 can generate and store respective ANN model updates 114-1, 114-2, . . . , 114-N. The ANN model updates 114 can represent corrections (e.g., training feedback) for the initial ANN model 112, which can comprise modification to or be used to modify the weights, biases, and/or activation functions of the initial ANN model 112. Although, in some examples, the ANN model updates 114 represent an entirety of the initial ANN model 112 with a local update by a particular edge device 103 incorporated therein.

The edge devices 103 can encrypt the updates 114 using a respective edge device-specific identifier 118-1, 118-2, . . . , 118-N, which may also be referred to as a key. Within the memory device of the memory sub-system 106 of each edge device 103, one or more respective blocks 120-1, 120-2, . . . , 120-N can be secured by respective hardware 122-1, 122-2, . . . , 122-N of the memory sub-system 106. The hardware 122 can secure the blocks 120 by isolating access to the blocks 120 so that only particular information can be stored there, and the blocks are not generally accessible for storage. In some embodiments, the blocks 120 are secured by the hardware 122 such that they may only be programmed by a manufacturer of the memory sub-system 106. In some embodiments, the blocks 120 are secured by the hardware 122 such that only root level access to the memory sub-system 106 allows any modification to the data stored in the blocks 120. The edge device-specific identifier 118 can be stored in the secured blocks 120 (e.g., by a manufacturer of the memory sub-system 106).

The edge devices 103 can transmit the respective encrypted ANN model updates 114-1, 114-2, . . . , 114-N to the server 102, which can store the encrypted ANN model updates 114-S. The edge devices 103, in some examples, are configured not to send the local data to the server 102 in order to keep such data secure. In some embodiments, as part of establishing root of trust for authentication, the server 102 can be paired with the edge devices 103 and receive the edge device-specific identifiers 118 therefrom for purposes of authentication and/or later decryption of information received from the edge devices 103.

The server 102 can be configured to determine whether respective encrypted updates 114-1, 114-2, . . . , 114-N received from the edge devices 103 are authentic. The server 102 can decrypt the respective encrypted updates 114-1, 114-2, . . . , 114-N in response to determining that the respective updates 114-1, 114-2, . . . , 114-N are authentic. The server 102 can store the decrypted updates 114-S.

The server 102 can aggregate decrypted updates 114-S into a federated ANN model 116-S. The server 102 can use any method of aggregating the respective updates 114, such as averaging, weighted averaging (e.g., based on differences in processing power of the edge devices 103 from which updates 114 are received, based on an amount of training data used by the edge devices 103 to create the updates, or other methods of weighted averaging), etc. In some embodiments, the server 102 can aggregate the updates 114-S according to a secure multiparty computation protocol.

The server 102 can deploy copies of the federated ANN model 116-1, 116-2, . . . , 116-N to the edge devices 103. In some embodiments, the server 102 can be configured to deploy the federated ANN model 116 to those of the plurality of edge devices 103 from which authentic respective encrypted updates 114 were received. This can further improve security of the system 100 by preventing possibly malicious actors from receiving a copy of the federated ANN model 116. In some embodiments, the server 102 can be configured to encrypt the federated ANN model 116-S prior to deployment. For example, the server 102 can encrypt the federated ANN model 116-S using an apparatus-specific identifier 118-S, which can be analogous to the edge device-specific identifiers 118-1, 118-2, . . . , 118-N. The apparatus-specific identifier 118-S of the server can be stored in one or more blocks of a memory device of the memory sub-system 106-S secured by hardware of the memory sub-system 106-S.

In an example, the server 102 can determine that the first edge device-specific identifier 118-1 associated with the first encrypted update 114-1 from the first edge device 103-1 is authentic, determine that the second edge device-specific identifier 118-2 associated with the second encrypted update 114-2 from the second edge device 103-2 is authentic, and determine that the third edge device-specific identifier 118-N associated with the third encrypted update 114-N from the third edge device 103-N is not authentic. In response to determining that the first and second edge-device specific identifiers 118-1, 118-2 are authentic, the server 102 can decrypt the first and second encrypted updates 114-1, 11-2, aggregate the first and second decrypted updates into the federated ANN model 116-S, and deploy the federated ANN model 116-S to the first and second edge devices 103-1, 103-2. In response to determining that the third edge device-specific identifier 118-N is not authentic, the server 102 will not aggregate the third update 114-N from the third edge device 103-N into the federated ANN model 116-S.

The edge devices 103 can execute the federated ANN model 116 to provide the same function as provided by execution of the initial model 114, albeit more efficiently than execution of the initial model 114. The edge devices 103 can be configured to operate according to the federated ANN model 116. In some examples, one or more of the edge devices 103 are drones.

FIG. 2 is a functional block diagram for authentication based secure federated learning. An apparatus 202, such as the server 102 illustrated in FIG. 1, can be configured to deploy an initial ANN model to a plurality of edge devices 203-1, 203-2, . . . , 203-N. In FIG. 2, the apparatus 202 is illustrated as a cloud to emphasize that the server 202 can be implemented in a cloud computing environment and is not necessarily a standalone piece of hardware. The apparatus can be configured to receive respective encrypted updates to the initial ANN model from each of the plurality of edge devices 203 that have trained the initial ANN model. As illustrated at 218, the updates can be encrypted with edge device-specific identifiers 218 of the edge devices 203. As illustrated at 224, the apparatus can aggregate the respective updates into a federated ANN model. The cycle symbol next to the secure federation aggregation 224 indicates that the aggregation process can be a cycle rather than a single event. That is, the edge devices 203 may continue to train either the initial ANN model or the federated ANN model and continue to provide secure updates to the apparatus 202, which may aggregate additional updates into a further updated federated ANN model (e.g., to further improve the federated ANN model).

The various security measures described herein can help prevent intrusions or attacks from malicious parties 226. For example, the apparatus 202 can use a secure multiparty computation protocol when aggregating updates from various edge devices 203, making it difficult or impossible for a malicious party 226 to reverse engineer individual updates based on the federated model. If the malicious party were otherwise able to reverse engineer such individual updates, the malicious party 226 might be able to learn specific information about an individual edge device 203 or its operation. Although the malicious party 226 is illustrated as being separate from the edge devices 203, the system also functions to help prevent an individual edge device 203 from acting as the malicious party 226.

In some examples, the edge devices 203 can be drones. The initial and/or federated ANN model can be configured to cause the drones to search an area for deforestation and to determine (e.g., based on imaging acquired by the drone), whether deforestation is occurring. A rogue drone acting as the malicious party 226 could be programmed to see more green than actually exists in its captured imaging, thereby falsely reporting results. If such false results were used to train and update the ANN model, and those updates were aggregated into a federated model distributed to other drones, the overall functionality of the system could be diminished. As another example, the rogue drone could use a differently updated local model in an attempt to learn what data other drones have sent. In another example, the malicious party 226 could attempt to compromise the apparatus 202 (e.g., server), for example, in order to learn the identities of the individual edge devices 203. The apparatus 202 could then send a maliciously updated federated ANN model with a valid key, causing an update to other drones.

One or more embodiments described herein can help prevent attempts by malicious parties 226 from succeeding, for example, by using a two-tiered approach where both communications from the edge devices 203 and from the apparatus 202 are secured and authenticated before being used within the system. Such a system can help prevent either malicious updates to a federated ANN model, which could affect many edge devices 203, or individual malicious updates targeting a particular edge device 203.

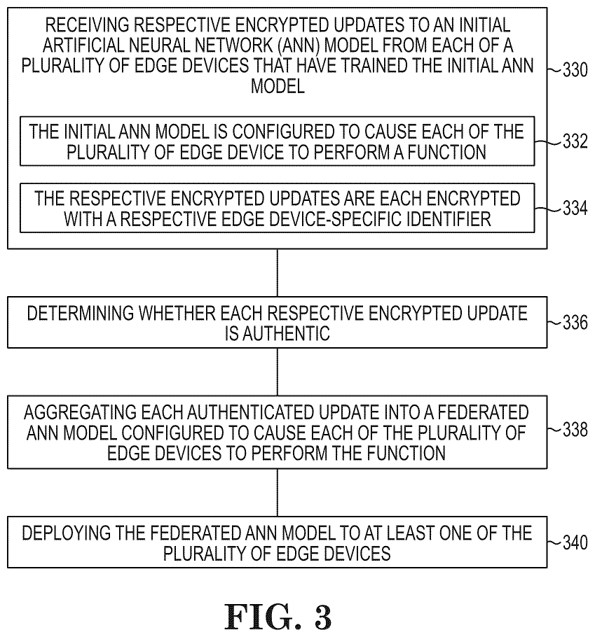

FIG. 3 is a flow diagram corresponding to a method for authentication based secure federated learning. The method may be performed, in some examples, using a computing system such as those described with respect to FIG. 1. The method can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method is performed by or using the server 102 and/or the devices 103 shown in FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

In some embodiments, the method can be performed by a server, such as the server 102 illustrated in FIG. 1. At 330, a method can include receiving respective encrypted updates to an initial ANN model from each of a plurality of edge devices that have trained the initial ANN model. The encrypted updates can be received as signals indicative of at least one of an updated weight, bias, and activation function of the initial ANN model in cyphertext. As illustrated at 332, the initial ANN model can be configured to cause the plurality of edge devices to perform a function. As illustrated at 334, the respective encrypted updates are each encrypted with a respective edge device-specific identifier, which can be stored in one or more blocks of a memory device of the respective edge device. The one or more blocks of the memory device can be secured by hardware that isolates access to the one or more blocks.

At 336, the method can include determining whether each respective encrypted update is authentic. For example, an encrypted update can be authenticated by determining whether an edge device-specific identifier of the edge device from which the encrypted update is received is known to the server. As another example, encrypted updates can be authenticated by determining whether a known (e.g., known to the server) edge device-specific identifier of the edge device from which the encrypted update is received is useful for decrypting the encrypted update. Other authentication methods are possible.

At 338, the method can include aggregating each authenticated update into a federated ANN model configured to cause each of the plurality of edge devices to perform the function. Aggregating each respective update can include aggregating according to a secured multiparty computation protocol.

Unauthenticated updates are not aggregated into the federated ANN model. The federated ANN model is configured to cause the plurality of edge devices to perform the function in a more efficient or otherwise better manner than the initial ANN model due to the federated learning that has occurred.

At 340, the method can include deploying the federated ANN model to at least one of the plurality of edge devices. For example, the federated ANN model can be deployed to those of the plurality of edge devices from which authenticated updates are received.

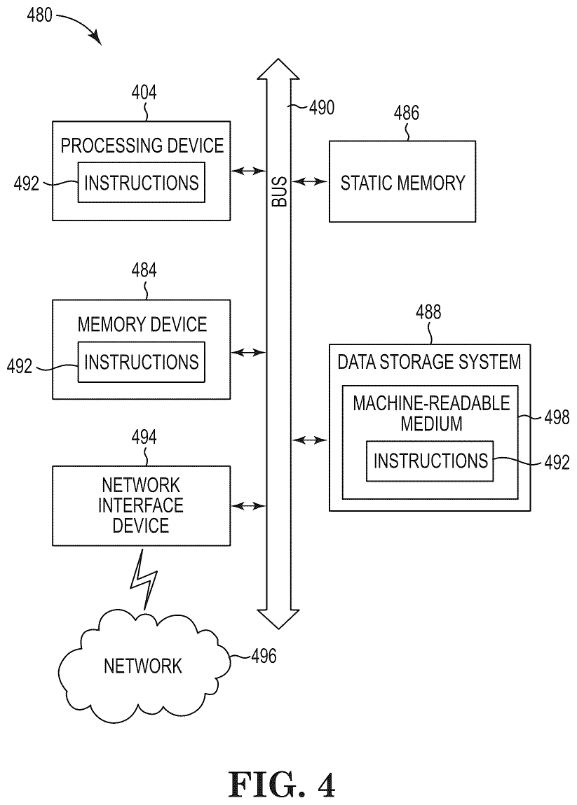

FIG. 4 is a block diagram of a computer system in which embodiments may operate. A set of instructions for causing a machine to perform any of the methodologies discussed herein can be executed within the computer system 480. In some embodiments, the computer system 480 can correspond to a host system that includes, is coupled to, or utilizes a memory sub-system (e.g., the memory sub-systems 106-1, 106-2, 106-N, 106-S of FIG. 1). The computer system 480 can be used to perform the operations described herein (e.g., to perform operations by the processors 104-1, 104-2, 104-N, 104-S of FIG. 1). In alternative embodiments, a machine can be connected (e.g., networked) to other machines in a local area network (LAN), an intranet, an extranet, the Internet, and/or wireless network. A machine can operate in the capacity of a server or a client machine in client-server network environment, as a peer machine in a peer-to-peer (or distributed) network environment, or as a server or a client machine in a cloud computing infrastructure or environment.

A machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. The term “machine” shall also be taken to include any collection of machines that individually or jointly execute a set (or multiple sets) of instructions to perform any one or more of the methodologies discussed herein.

The computer system 480 includes a processing device (e.g., processor) 404, a main memory 484 (e.g., read-only memory (ROM), flash memory, dynamic random access memory (DRAM) such as synchronous DRAM (SDRAM) or Rambus DRAM (RDRAM), etc.), a static memory 486 (e.g., flash memory, static random access memory (SRAM), etc.), and a data storage system 488, which communicate with each other via a bus 490.

The processing device 404 represents one or more general-purpose processing devices such as a microprocessor, a central processing unit, or the like. More particularly, the processing device 404 can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. The processing device 404 can also be one or more special-purpose processing devices such as an application specific integrated circuit (ASIC), a field programmable gate array (FPGA), a digital signal processor (DSP), network processor, or the like. The processing device 404 is configured to execute instructions 492 for performing the operations and steps discussed herein. The computer system 480 can further include a network interface device 494 to communicate over the network 496.

The data storage system 488 can include a machine-readable storage medium 498 (also known as a computer-readable medium) on which is stored one or more sets of instructions 492 or software embodying any one or more of the methodologies or functions described herein. The instructions 492 can also reside, completely or at least partially, within the main memory 484 and/or within the processing device 404 during execution thereof by the computer system 480, the main memory 484 and the processing device 404 also constituting machine-readable storage media. The machine-readable storage medium 498, data storage system 488, and/or main memory 484 can correspond to the memory sub-systems 106-1, 106-2, 106-N, 106-S of FIG. 1.

In one embodiment, the instructions 492 include instructions to implement functionality corresponding to authentication based secure federated learning. While the machine-readable storage medium 499 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies described herein. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

Embodiments also relate to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

Embodiments can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a ROM, RAM, magnetic disk storage media, optical storage media, flash memory devices, etc.

In the foregoing specification, embodiments have been described with reference to specific example embodiments thereof. It will be evident that various modifications can be made thereto without departing from the broader spirit and scope of embodiments as set forth in the following claims. The specification and drawings are, accordingly, to be regarded in an illustrative sense rather than a restrictive sense.

What is claimed is:

1. A method, comprising:
receiving respective encrypted updates to an initial artificial neural network (ANN) model from each of a plurality of edge devices that have trained the initial ANN model;
wherein the initial ANN model is configured to cause each of the plurality of edge device to perform a function;
wherein the respective encrypted updates are each encrypted using a respective edge device-specific identifier;
determining whether each respective encrypted update is authentic;
aggregating each authenticated update into a federated ANN model configured to cause each of the plurality of edge devices to perform the function; and
deploying the federated ANN model to at least one of the plurality of edge devices.

2. The method of claim 1, wherein the respective edge device-specific identifier is stored in one or more blocks of a memory device of the respective edge device; and
wherein the one or more blocks of the memory device are secured by hardware that isolates access to the one or more blocks.

3. The method of claim 2, wherein aggregating each respective encrypted update comprises aggregating according to a secure multiparty computation protocol.

4. The method of claim 1, comprising aggregating each authenticated update into the federated ANN model without aggregating unauthenticated updates.

5. The method of claim 1, wherein deploying the federated ANN model to at least one of the plurality of edge devices comprises deploying the federated ANN model to those of the plurality of edge devices from which authenticated updates are received.

6. The method of claim 1, wherein receiving respective encrypted updates to the initial ANN model comprises receiving signals indicative of at least one of an updated weight, bias, and activation function of the initial ANN model in cyphertext.

7. An apparatus comprising:
a memory device;
a processor coupled to the memory device and configured to:
determine whether a first edge device-specific identifier associated with a first encrypted update to an initial artificial neural network (ANN) model received from a first edge device is authentic;
determine whether a second edge device-specific identifier associated with a second encrypted update to the initial ANN model received from a second edge device is authentic; and
in response to determining that the first and the second edge device-specific identifiers are authentic:
decrypt the first and the second encrypted updates;
aggregate the first and the second decrypted updates into a federated ANN model according to a secure multiparty computation protocol; and
deploy the federated ANN model to the first and the second edge devices.

8. The apparatus of claim 7, wherein the processor is further configured to:
determine whether a third edge device-specific identifier associated with a third encrypted update to the initial ANN model received from a third edge device is authentic; and
aggregate the first and the second decrypted updates into a federated ANN model without the third encrypted update in response to determining that the third edge device-specific identifier is not authentic.

9. The apparatus of claim 8, wherein the processor is further configured to deploy the initial ANN model to the first, the second, and the third edge devices.

10. The apparatus of claim 7, wherein the processor is configured to encrypt the federated ANN model prior to deploying the federated ANN model to the first and the second edge devices.

11. The apparatus of claim 10, wherein the one or more blocks of the memory device are secured by hardware that isolates access to the one or more blocks;
wherein the one or more blocks store an apparatus-specific identifier; and
wherein the processor is configured to encrypt the federated ANN model using the apparatus-specific identifier.

12. A system, comprising:
a plurality of edge devices, each configured to:
receive respective data from operation in a respective location;
train an initial artificial neural network (ANN) model with the respective data;
generate a respective update to the initial ANN model;
encrypt the respective update using a respective edge device-specific identifier; and
transmit the respective encrypted update to a server; and
the server, configured to:
determine whether the respective encrypted update is authentic;
decrypt the respective encrypted update in response to determining that the respective encrypted update is authentic; and
aggregate a plurality of decrypted respective updates into a federated ANN model.

13. The system of claim 12, wherein the server is configured to aggregate the plurality of decrypted respective updates into the federated ANN model according to a secure multiparty computation protocol.

14. The system of claim 13, wherein the server is further configured to deploy the federated ANN model to the plurality of edge devices.

15. The system of claim 14, wherein the server is further configured to encrypt the federated ANN model prior to deployment.

16. The system of claim 12, wherein the server is further configured to deploy the federated ANN model to those of the plurality of edge devices from which authentic respective encrypted updates are received.

17. The system of claim 12, wherein the respective update comprises at least one of an updated weight, bias, and activation function of the initial ANN model.

18. The system of claim 12, wherein each of the plurality of edge devices comprises:
a respective processor; and
a respective memory coupled to the respective processor, wherein the respective memory includes one or more blocks secured by hardware that isolates access to the one or more blocks;
wherein the respective edge device-specific identifier is stored in the one or more blocks.

19. The system of claim 18, wherein the plurality of edge devices comprise drones;
wherein the initial ANN model is configured to be executed by the respective processor to cause the drone to perform a function; and
wherein the federated ANN model is configured to be executed by the respective processor to cause the drone to perform the function more efficiently than the initial ANN model.

20. The system of claim 18, wherein the plurality of edge devices comprise drones; and
wherein the memory comprises flash memory.
